(19) United States
(12) Patent Application Publication
(10) Pub. No.: US 2011/0011922 A1
(43) Pub. Date: Jan. 20, 2011

(54) MATERIALS FOR AN METHOD FOR MANUFACTURING A DIVIDED CONTAINER AND RESULTING DIVIDED CONTAINER

(75) Inventor: Troy Little, Thomasville, PA (US)

Correspondence Address: BARNES & THORNBURG LLP, 750-17TH STREET NW, SUITE 900, WASHINGTON, DC, 20006-4675, US

(73) Assignee: York container company, York, PA (US)

(21) Appl. No.: 12/834,136

(22) Filed: Jul. 12, 2010

Related U.S. Application Data
(60) Provisional application No. 61/225,372, filed on Jul. 14, 2009.

(51) Int. Cl. B65D 25/04; B31B 1/14

(52) U.S. Cl. 229/120.02; 493/56

(57) ABSTRACT

A method of manufacturing containers and resulting containers and associated preassemblies and blanks are provided, which, when utilized, result in containers having an interior formed by a primary blank serving as an exterior of the container. The interior includes a cross support formed from a supplementary blank that is configured and adhered to opposed panels of the primary blank so as to function also as a divider of the interior of the container. The cross support is formed as part of the set up or final assembly of exterior of the container.

This application claims the benefit of U.S. Provisional Patent Application No. 61/225,372, filed on Jul. 14, 2009, the entirety of which are being incorporated herein by reference in their entirety. The invention relates in general to the manufacture of packaging/containers that may be readily used to transport product and/or display the contents of the containers following delivery, as specified in the independent claims.

### BACKGROUND OF THE INVENTION

Various containers are conventionally provided as packaging for shipping and/or for display of product in a retail environment to prospective customers. As is conventionally known in the industry, such containers can be transported to manufacturing and/or retail environments for use in shipping or display in knock-down form, i.e., flattened but otherwise being glued, stapled or otherwise secured together, such that they are already substantially pre-assembled. Such knock-down form containers are also referred to as preassemblies. In such a “knockdown” state (i.e., knocked down or not set-up), personnel or equipment used in the final assembly of the product container need only open the sides and or ends of the container and affix the package bottom wall into its assembled condition. As a result, such container assembly may be performed such that the product can be placed into a resulting assembled container for shipping or as a display package.

Conventionally, it has been deemed advantageous at times to stack a plurality of such containers, one on top of the other for the purposes of storage, transport to a retail or manufacturing environment or during display in the retail environment. In these uses, it is necessary that the containers stacked above the bottom-most package are amply supported. Additionally, it is useful if the design of the containers is such that a stack of such containers, when filled with product, will not collapse.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

In accordance with illustrated embodiments, a method of manufacturing containers and resulting containers and associated preassemblies and blanks are provided, which, when utilized, result in containers having an interior formed by a primary blank serving as an exterior of the container. The interior includes an auxiliary or cross support formed from a first supplementary blank that is configured and adhered to opposed panels of the primary blank so as to function also as a divider of the interior of the container. The cross support is formed as part of the set up or final assembly of exterior of the container.

In accordance with at least one illustrated embodiment, a second supplementary blank is attached to one of the opposed panels and the first supplementary blank is attached to the second supplementary blank. The second supplementary blank is dimensioned to form a double wall with the opposed panel to which it is affixed. A section of the first supplementary blank affixed to the other opposed panel and an overlap panel affixed to the other opposed panel form a double wall with the other opposed panel.

Further, the illustrated embodiments provide at least end supports with significantly less material than is conventionally required for similar conventional containers with auxiliary stacking supports. As a result, the amount of material incorporated in container designs utilizing the inventive concept may be reduced significantly in comparison to what is conventionally required to provide similarly robust containers. This reduction in material results in a reduction in the container weight and resources expended to produce the container, while still providing improved container strength; moreover, the reduction in container weight also reduces the amount of resources required to transport the container in preassembly and finally assembled and packed states.

These illustrated embodiments are achieved by a combination of features recited in the independent claims. Accordingly, dependent claims prescribe further detailed implementations of the present invention.

### BRIEF DESCRIPTION OF THE DRAWINGS

Various embodiments are described herein, by way of example only, with reference to the accompanying drawings. With specific reference now to the drawings, it should be understood that the particulars shown are by way of example and for purposes of discussion of illustrated embodiments only, and are presented in order to provide what is believed to be a useful and readily understood description of the principles and concepts of the invention. In this regard, no attempt is made to show structural details of the invention in more detail than is necessary for a fundamental understanding of the invention, the description taken with the drawings making apparent to those skilled in the art how the several forms of the invention may be embodied in practice.

Accordingly, a more complete understanding of the present invention and the utility thereof may be acquired by referring to the following description in consideration of the accompanying drawings, in which like reference numbers indicate like features, and wherein:

FIG. 1 illustrates a side perspective view of a container manufactured in accordance with an illustrated embodiment.

FIG. 2 illustrates a top view of the container of the type illustrated in FIG. 1

FIG. 3 illustrates an example of a primary blank used in manufacturing the container of the type illustrated in FIG. 1.

FIG. 4 illustrates an example of a first type of supplementary blank used in manufacturing the container of the type illustrated in FIG. 1.

FIG. 5 illustrates an example of a second type of supplementary blank used in manufacturing the container of the type illustrated in FIG. 1.

FIG. 6 illustrates the pre-assembly materials for the container of the type illustrated in FIG. 1 in a first stage of pre-assembly.

FIG. 7 illustrates the pre-assembly materials for the container of the type illustrated in FIG. 1 in a second stage of pre-assembly.

FIG. 8 illustrates the pre-assembly materials for the container of the type illustrated in FIG. 1 in a third stage of pre-assembly.

FIG. 9 illustrates the pre-assembly materials for the container of the type illustrated in FIG. 1 in a fourth stage of pre-assembly.

FIG. 10 illustrates a manufacturing methodology provided in accordance with the claimed invention.

FIG. 11 illustrates a top view of a container manufactured in accordance with another illustrated embodiment.

### DETAILED DESCRIPTION OF THE INVENTION

In the following description of various invention embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Shipping, display and dual-use containers (e.g., those containers that may be used for both shipping and display), often suffer from a conventional problem in that the weight of product in the containers can require additional support and/or reinforcement for the containers to enable stacking of containers including product. As explained above, it is useful to be able to stack a plurality of containers one on top of the other for the purposes of transport to or from a manufacturing or retail environment or during storage and/or display in a manufacturing or retail environment. This ability (also known as “stackability”) requires that containers stacked above the bottom-most package are amply supported and also requires that a stack of a number of such containers, when filled with product, will not collapse.

Conventionally, there are various container designs that provide increased stackability by including, for example, types of corner supports or auxiliary supports that utilize additional material and components to increase the vertical stability of the container. However, such containers may require that an auxiliary support be inserted by hand (i.e., cannot be installed using automated or semi-automated machinery). Accordingly, such manual assembly of a preassembly into a fully constructed container can decrease assembly and packing speed and can be cost prohibitive to using such pre-assembly and container designs.

Moreover, depending on the design of the preassembly, the number of separate actions needed to assemble such container designs (conventionally referred to as the number of “touches” required for assembly) varies greatly and may be significant; thus, a container requiring complex assembly requires a greater number of touches than a container requiring relatively simple assembly.

The skill level and time required for manual assembling such containers from a knock-down form varies depending on the required number of touches for assembling the container. The time required for assembling conventional container including such auxiliary supports of some sort or another may be somewhat lengthy as assembly of a container may require a number of separate actions to be performed by the final human container assembler

An additional problem for some conventional container designs is that some designs sometimes do not include a container top; as a result, stacked containers including product rely on the bottom of an uppermost container resting on the contents of a container upon which it is placed. In such designs, the lack of a container top can further exacerbate the need for improving the stackability of the designs because the omission of the container top results in the inability to use significant corner supports that would rely on the presence of a container top. Moreover, such designs also rely, to some extent or another, on the rigidity or structural support provided by the contents or product included in the container. Therefore, it such designs are often used for shipping and/or displaying contents comprising bottles or boxes that enable stable, rigid and structural support provided within the interior of a container.

Another problem with such conventional, stackable container designs is the increased height, length, width and weight of such containers due to the added material provided for the auxiliary supports. Alternatively, where the designs' outer dimensions are not increased, the amount of space taken up by the added material reduces the capacity of the container. Further, where sidewalls of such containers are reinforced with additional layers of material, handpacking of such layers further increases the time necessary to finally assemble such containers and further increase the weight and material expended for such containers.

Therefore, although the use of such conventional stackable container designs is useful, the increased time for final assembly, increased dimensions and weight of the containers, and limitations on the amount and type of contents to be included in such containers are deficiencies of conventional designs.

Thus, there is a need for a stackable container design that includes auxiliary support and reinforcement of sidewalls but may be finally assembled as a container using automated or semi-automated equipment. Additionally, there is a need for a stackable container design that includes an auxiliary support that is adhered to the exterior material of the container during preassembly manufacture such that some amount of product or product containers may be stored in a partially assembled pre-assembly for transport to an interim product fulfillment facility.

Moreover, there is a need for a stackable container design with an omitted container top and a cross support and at least one end support (and optionally a plurality of end supports) that enable improved stackability of such a container.

There is also a need for such a design wherein the resulting container has a reduced affect on the overall dimensions and weight of the container, while both reducing the amount of material used in the container and reducing the number of touches required for final assembly of the container.

With this understanding in mind, a description of various invention embodiments is now provided.

According to at least one illustrated embodiment, there is provided a method of manufacturing containers and resulting containers and associated preassemblies and blanks are provided, which, when utilized, result in containers having an interior formed by a primary blank serving as an exterior of the container. The interior includes an auxiliary or cross support formed from a first supplementary blank that is configured and adhered to opposed panels of the primary blank so as to function also as a divider of the interior of the container. The cross support is formed as part of the set up or final assembly of exterior of the container.

In accordance with at least one illustrated embodiment, a second supplementary blank is attached to one of the opposed panels and the first supplementary blank is attached to the second supplementary blank. The second supplementary blank is dimensioned to form a double wall with the opposed panel to which it is affixed. A section of the first supplementary blank affixed to the other opposed panel and an overlap panel affixed to the other opposed panel form a double wall with the other opposed panel.

Understanding of the manufacturing of a container, blanks and/or preassemblies in accordance with embodiments may best be understood by first reviewing an illustration of a manufactured container provided in accordance with one illustrated embodiment.

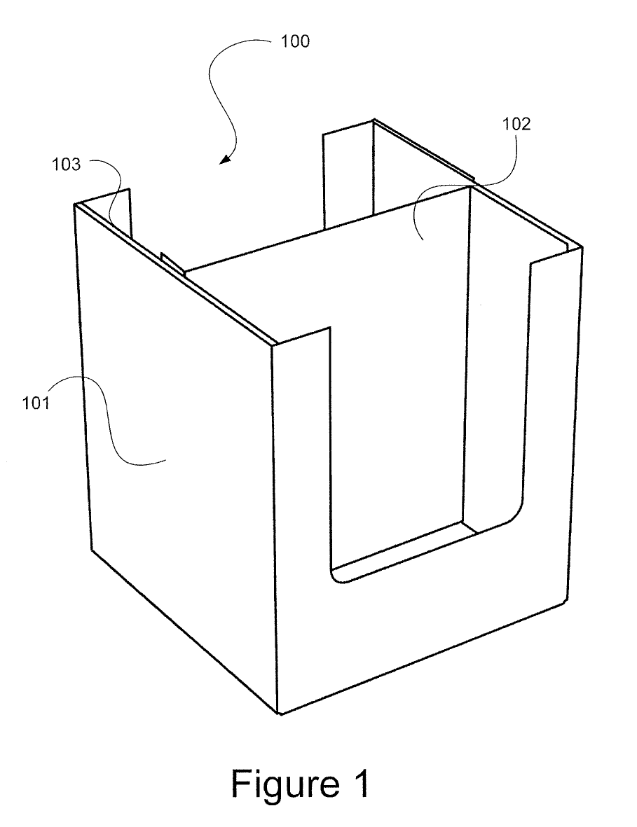

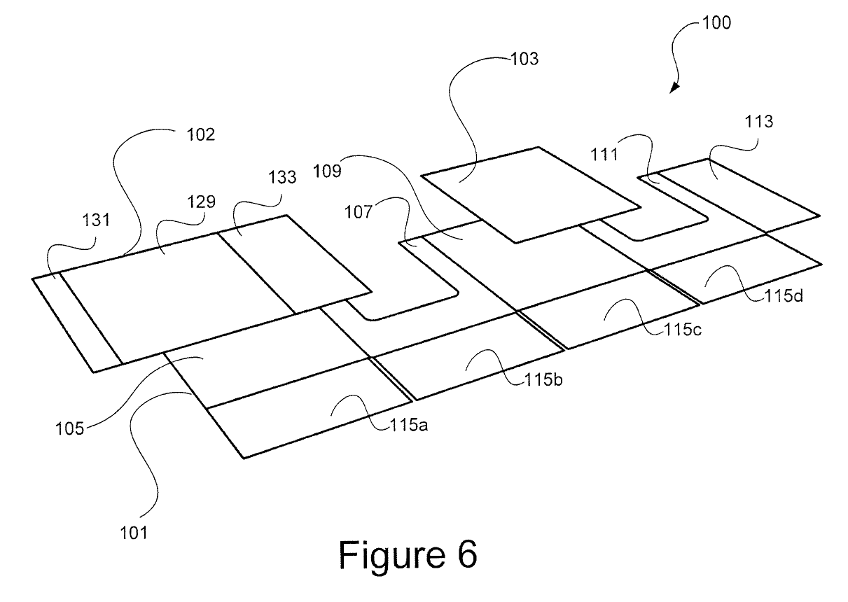

As illustrated in FIG. 1, one example of such a container 100 that may be, for example, a slotted bottom tray style container formed by a primary blank 101. The container 100 may include an interior defined between by the side walls of the primary blank 101 and a plurality of supports each formed by one of two types of supplementary blanks 102 and 103 included in the interior of the primary blank 101 following assembly. A first end support is formed by supplementary blank 103 and a second end support is formed by one section of supplementary blank 102 (with another section of supplementary blank 102 serving as a cross support/divider). As part of preassembly manufacture for a preassembly for container 100, the supplementary blanks 102, 103 may be adhered to the primary blank 101 as explained in connection with FIGS. 6-9 to provide for improved ease of final assembly for the container 100.

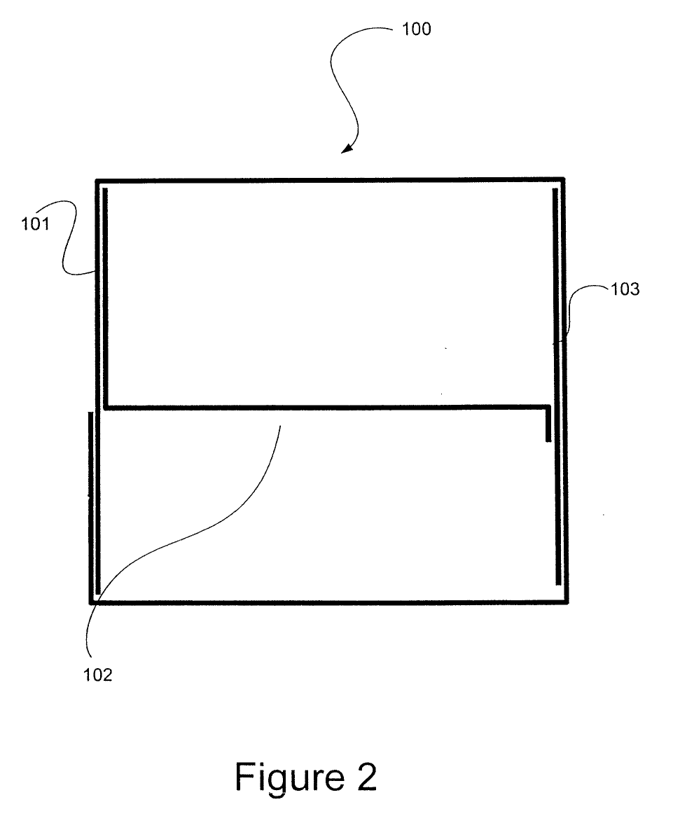

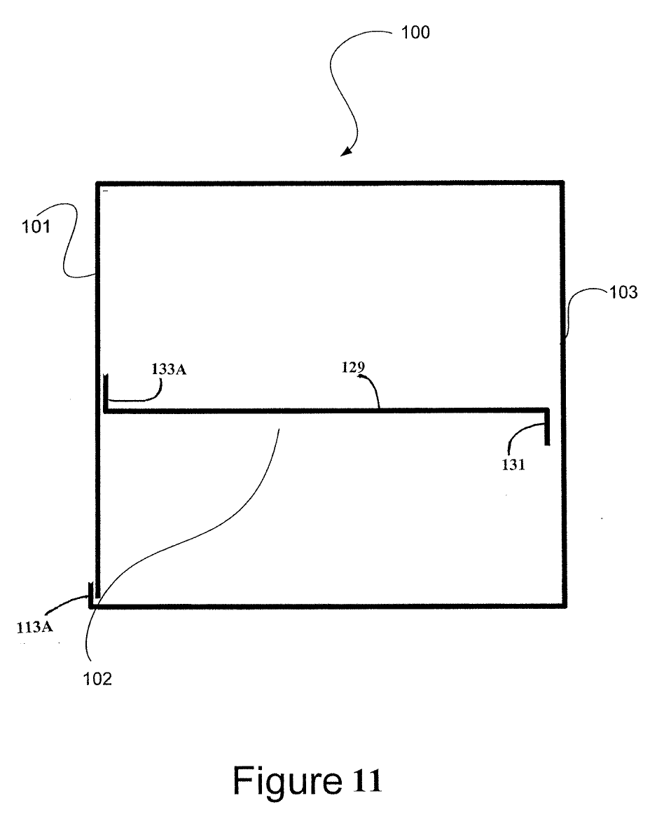

As shown in FIG. 2, which depicts a top view of the container 100, the end support formed by the supplementary blank 103 has a width substantial equal to the panel of the primary black to which it is attached to form a double wall. It should be appreciated that the end support formed by the supplementary blank 103 may span only a portion of the corresponding panel, e.g., a majority of the width of the corresponding panel of the container 100, if less strength is required. In some containers, the supplementary blank 103 may be eliminated as illustrated in the embodiment of FIG. 11.

The end support formed by a section of the supplementary blank 102 adhered to the opposing end wall may similarly span only a portion of the width of the panel of the primary blank, e.g., half or a majority of the width of the corresponding panel of the container 100. The remainder of the panel width is span by an additional overlapping panel of the primary bank there by forming a double wall. In some containers, the width of the attachment portion of the supplementary blank 102 and the overlapping panel may be minimized as illustrated in the embodiment of FIG. 11.

Such a container 100 may be used for various purposes including shipping and/or display on a display floor along with other such containers in a stack. However, it should be understood that the manufactured container may be any type of container including, for example, any carton, package, box, etc., of any suitable type; accordingly, the actual configurations of the primary blank 101 and the interrelationship with the supplementary blanks 102, 103 may change without departing from the scope of the embodiments. Thus, in accordance with illustrated embodiments, a method is provided of manufacturing containers and resulting containers 100 and associated preassemblies (the combination of 101, 102, 103) and blanks 101, 102, 103 (supplementary blanks 102, 103 being the blank that form the auxiliary supports when joined with primary blank 101); when utilized, the method results in containers 100 that include supplementary blanks 102, 103 that each provide auxiliary supports that serve as a mechanism for improving the stackability of the container 100, whereby the container 100 may be configured to bare larger amounts of force (e.g., weight) from a top direction.

Based on the illustrated examples of container designs provided with auxiliary supports as disclosed herein, it should be appreciated that the incorporation of the auxiliary supports increases stackability of the resulting containers without requiring a lengthier time period for final assembly and without a need for assemblers (either human or automated or semi-automated equipment) to have superior capabilities. This is because, as explained herein, the majority if not all of manipulation of the preassembly to form the auxiliary supports is already performed as part of the final assembly of the primary blank as the exterior of the container. As a result, additional touches needed to provide the auxiliary supports is reduced or eliminated relative to what would be conventionally required for installing or assembling conventional auxiliary supports.

Moreover, the adherence of the supplementary blank 102 to the panels of the primary blank 101 during preassembly manufacture enables the container 100 to be fully erected and used to transport additional product containers therein in a manner that has utility to both product and product container manufacturers. This is because, in at least one application, product containers, e.g., product bottles, boxes or the like, may be inserted in the container 100 prior to delivery to a facility, area or piece of equipment configured to place product in those product containers.

Conventionally, such a practice would involve the turning over of a shipping container to remove the product containers on a conveyer belt or the like to facilitate filling of the product containers with product. For example, such product containers may be product bottles to be filled with a liquid or semi-liquid product by equipment as the product containers are transported along by the conveyer belt. In such a situation, it should be appreciated that the bottles may be initially inserted up-side-down into the shipping container to facilitate those product containers being placed right-side-up on a conveyer belt by inverting the shipping container above the conveyer belt (such up-side-down placement also helps to ensure that product container do not collect foreign matter therein during transportation). However, in such a situation, conventional shipping container designs utilizing a cross support/divider would suffer from the problem that the cross support/divider would become dislodged from the shipping container because such conventional cross support/dividers are not adhered to the shipping container itself; accordingly, such conventional cross supports would require reinsertion or repositioning by hand, thereby extending the time necessary to re-pack the shipping container with product containers following insertion of product into those product containers.

Accordingly, the disclosed embodiments provide an improvement upon such conventional shipping containers because turning over the disclosed container 100 results in only included product containers being removed while an included cross support/divider remains in place.

Further, as mentioned above, the illustrated examples of container designs provide end supports with significantly less material than is conventionally required for similar conventional containers with auxiliary stacking supports. For example, the square footage of material incorporated in container designs utilizing the inventive concept may be reduced significantly. This reduction in material results in a reduction in the container weight and resources expended to produce the container, while still providing improved container strength.

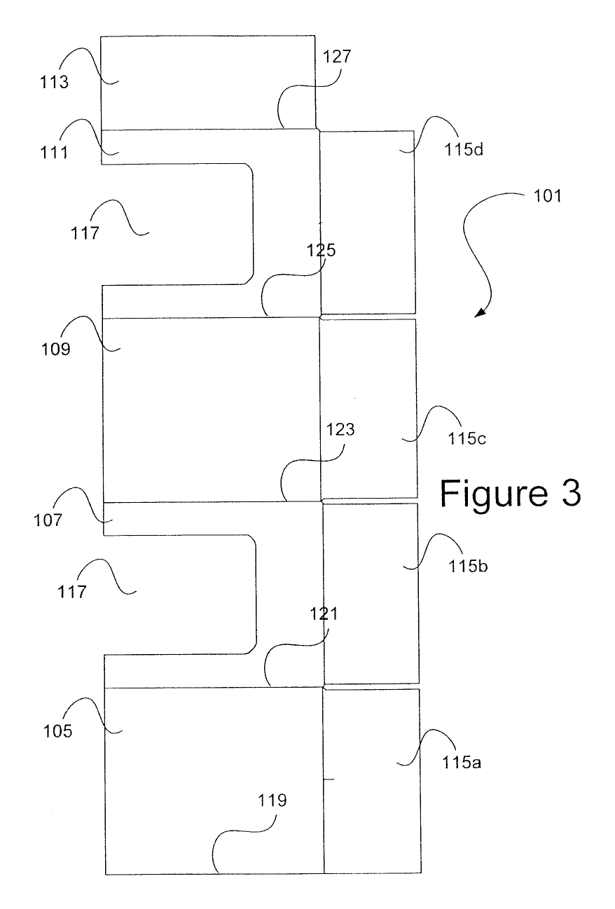

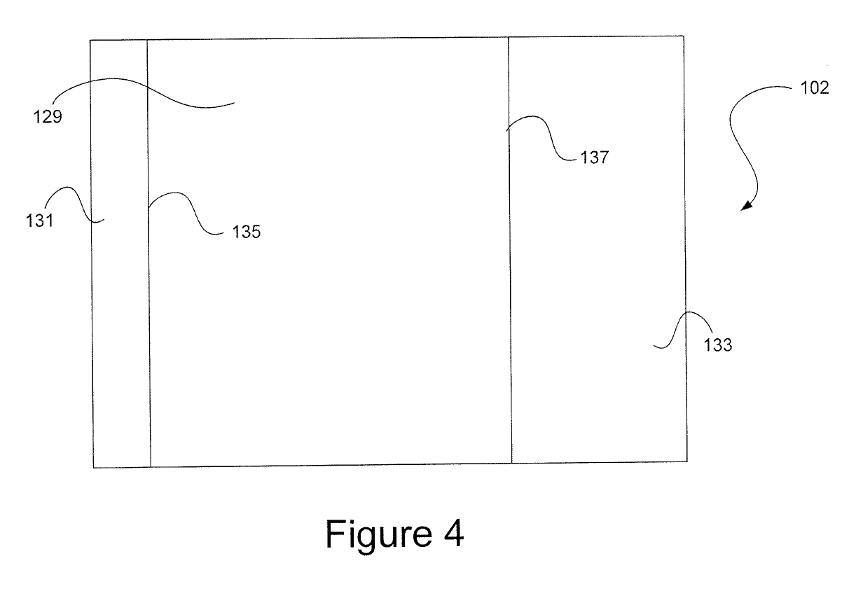

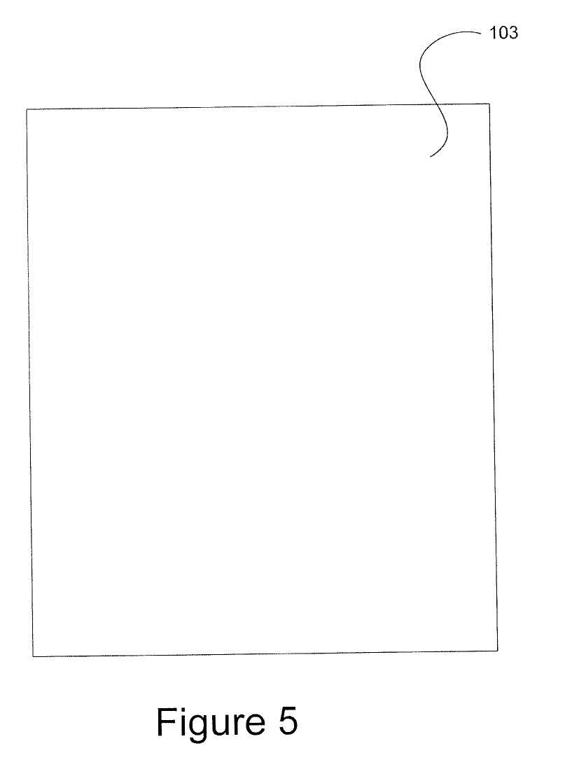

FIG. 3 illustrates an example of a primary blank 101, which may be thought of as a conventional tray type as illustrated in FIG. 1. The knockdown of the container 100 of FIG. 1 is manufactured by joining the primary blank 101 with supplementary blanks of two types 102, 103 (which may be thought of as pads) examples of which being illustrated in FIGS. 4 and 5, as explained herein. The primary blank 101 illustrated in FIG. 3 corresponds to an exterior of the container 100 illustrated in FIG. 1. Likewise, the container 100 also includes auxiliary supports, which are formed using supplementary blanks 102, 103 illustrated separately in FIGS. 4 and 5 (and in conjunction with primary blank 101 in FIGS. 6-9).

As shown in FIG. 3, the primary blank 101 includes a first end panel 105, a front side panel 107a second end panel 109, a back end panel 111 and a first end sub-panel 113. Each of panels 105-111 are coupled to corresponding bottom panels 115a-d; these bottom panels 115a-d cooperate as part of final assembly of the container 100 to form a bottom of the container 100.

First end panel 105 has two lateral edges 119 and 121, edge 121 being a fold line between the first end panel 105 and the front side panel 107. Front side panel 107 has two lateral edges 121 and 123, edge 123 being a fold line between the front side panel 107 and the second end panel 109. Second end panel 109 has two lateral edges 123 and 125, edge 125 being a fold line between the second end panel 109 and the back side panel 111. Back side panel 111 has two lateral edges 125 and 127, edge 127 being a fold line between the back side panel 111 and the first end sub-panel 113.

The front side panel 107 includes an optional aperture 117, which may be formed during manufacture of the blank 101 or may result from removal of a scored section included in front side panel 105. Further, the back side panel also includes an optional aperture 117, which may be formed during manufacture of the blank 101 or may result from removal of a scored section included in front side panel 105.

Further, although not illustrated in any of the figures, it should be appreciated that the containers provided in accordance with the disclosed embodiments may, in fact, include one or more top panels that provide a top of the container. Thus, in the same way that a scored, tear-away portion of the front side panel 105 may be removed to reconfigure the container as a display container, so may such top panels be removed to provide access to the contents of the container.

FIGS. 4 and 5 illustrate an example of a first type of supplementary blank 102 used in manufacturing the container of the type illustrated in FIG. 1. The supplementary blank 102 includes a major section 129 and two minor sections 131, 133. The major section shares a fold line 135 with the first minor section 131; likewise, the major section 129 shares a fold line 137 with the second minor section 133.

FIG. 5 illustrates an example of a second type of supplementary blank 103, which includes a single section.

FIG. 6 illustrates the relative placement of the primary blank 101 and supplementary blanks 102, 103 illustrated in FIGS. 3-5 with respect to each other to provide a preassembly as illustrated in FIGS. 6-9 and the container illustrated in FIGS. 1-2.

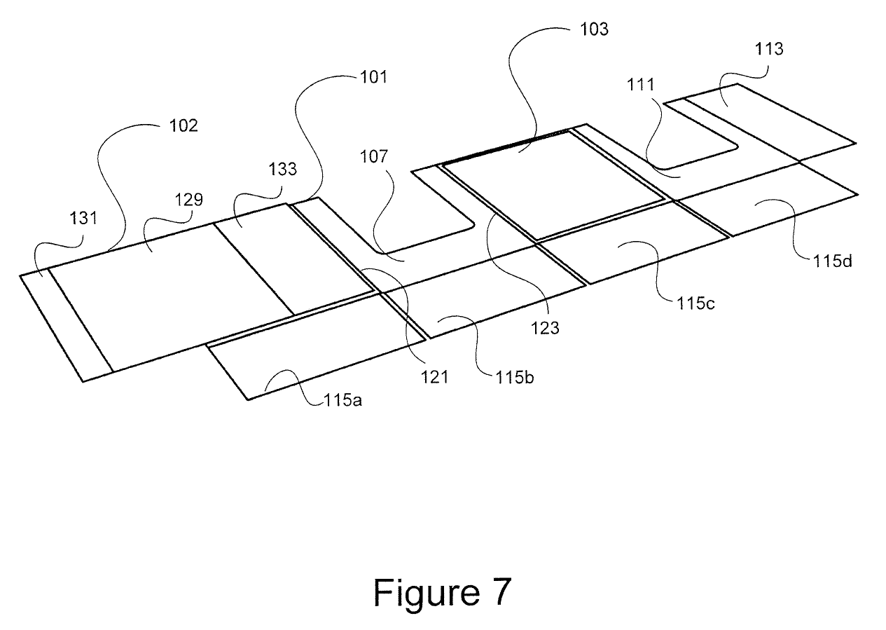

As illustrated in FIG. 6, the primary and supplementary blanks 101-103 may be configured so as to interact in a manner that enables the end supports to be formed easily and quickly as part of the final assembly of the container 100 from a corresponding preassembly (also referred to, for convenience, as preassembly 100). Accordingly, the dimensions for the blanks 101-103 and their constituent panels, walls and sections may be selected so as to facilitate the positioning of the supplementary blanks 102, 103 with respect to the primary blank 101 as illustrated in FIG. 6. The relative dimensions of certain panels of the primary blank 101 and sections of the supplementary blanks 102, 103 are discussed further with reference to FIGS. 7-9.

As mentioned above and will be further appreciated from the remaining disclosure by one of ordinary skill in the art, the container 100 may be used to ship, store or display product therein in a retail environment. Thus, subsequent to arrival at a retail environment or off-site fulfillment or contract packaging facility, a knockdown version of the container 100 (i.e., preassembly 100) may be finally assembled and product placed in the container 100 for transport and/or display. Therefore, it should be appreciated that, as a first operation in manufacturing the preassembly for the container 100, the faces of the primary blank 101 and supplementary blanks 102, 103 may be affixed together at various locations.

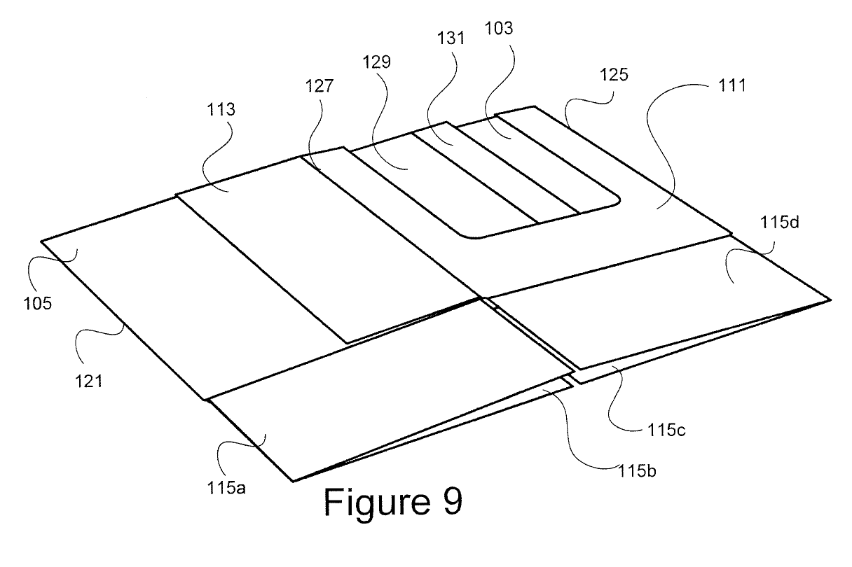

Thus, as shown in FIG. 4, a preassembly may be provided wherein the primary blank 101 and supplementary blanks 102, 103 are adhered to one another via adhesive but the panels, walls, etc. are not configured for final assembly. As a result, a preassembly 100 (such as that illustrated in FIG. 9) may be manufactured and may be delivered to a location for final assembly and placement of product or product containers; such a preassembly may be effectively and easily stacked with other preassemblies because such preassemblies are flat having not yet been built or finally assembled as shown in FIG. 1.

Thus, returning to the manufacture of the preassembly, one or more portions of the primary blank 101 and supplementary blanks 102, 103 may be adhered to one another. Thus, for example, adhesive may be provided on the underside of sections 131 and 133 of supplementary blank 102 and the underside of supplementary blank 103. This placement of adhesive for the two supplementary blanks 102, 103 enables the supplementary blanks to be properly erected into the end supports when the container is finally assembled.

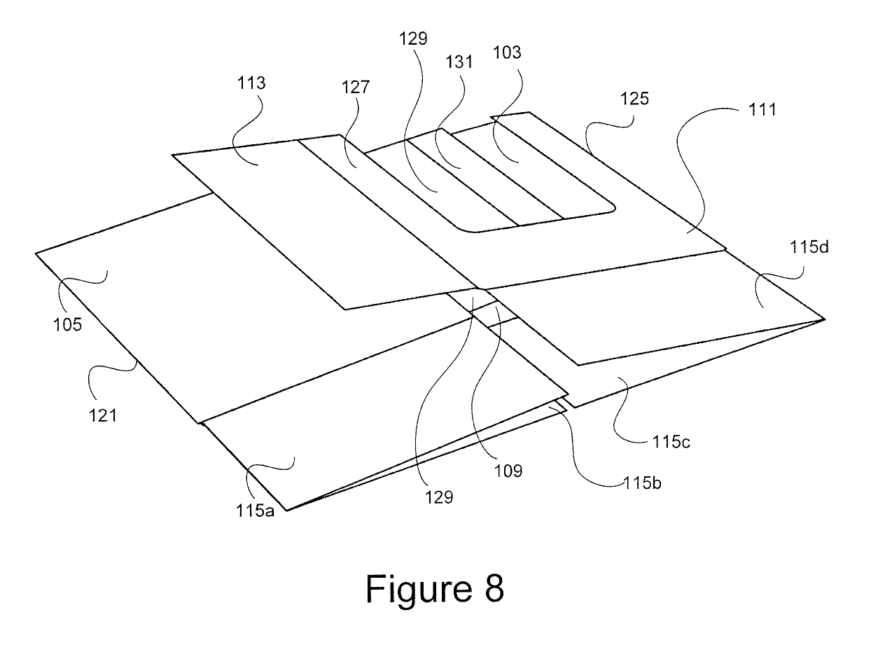

Alternatively, adhesive may be provided on the upper side of that portion of the first end panel 105 that interfaces with the second minor panel 133 and the underside of section 131 of the first supplementary blank 102. Additionally, adhesive may be provided on the top side of the first end sub-panel 113 so as to facilitate adherence between the first end sub-panel 113 and the first end panel 105, as explained herein in connection with FIG. 8.

Thus, when primary blank 101 is brought into contact with the supplementary blanks 102, 103, the blanks are joined. It should be understood that this coupling may be made using, for example, adhesive such as glue, staples, tape, etc., so as to produce the preassembly, wherein the positioning of supplementary blanks 102, 103 in cooperation with primary blank 101 is controlled.

More specifically, and with reference to FIGS. 6-7, the supplementary blank 102 is placed over the first end panel 105 such that the outer edge of the supplementary blank minor section 133 is aligned with but slightly adjacent to the fold line 121 provided between the first end panel 105 and the front side panel 107. As a result, the second minor section 133 of the supplementary blank 102 is adhered to the first end panel 105.

Likewise, the supplementary blank 103 is placed over the second end panel 109 such that the outer edges of the supplementary blank 103 are aligned with but slightly adjacent to the fold lines 123, 125 for the second end panel 109. As a result, the supplementary blank 103 is adhered to the second end panel 105.

Although not illustrated in a separate figure, as part of preassembly manufacture, the primary blank 101 is folded along fold line 121 so that the combination of the first end panel 105 and supplementary blank 102 are carried towards the front side panel 107. As a result, of that operation, adhesive applied on the upper surface of the first minor section 131 of the supplementary blank 102 comes into contact with the upper surface of the second supplementary blank 103 thereby adhering the two surfaces together.

Subsequently, as shown in FIG. 8, the primary blank 101 is folded along fold line 125 so that the first end sub-panel 113 are carried towards the first end panel 105 stacked on top of the front side panel 107. As a result, adhesive applied on the upper surface of the first end sub-panel 113 of the primary blank 101 comes into contact with the first end panel 105 thereby adhering the two surfaces together as illustrated in FIG. 9

Note, the relative dimensions of the panels of the primary blank 101 and the sections of the supplementary blanks 102, 103 enable the preassembly to lay flat following manufacture. However, the major section 129 of the supplementary blank 102 is forced to be positioned as a cross support that divides the container interior when the preassembly 100 is opened such that the first end panel 105 is angled away from the front side panel 107 along the fold line 121 and the back side panel 111 is angled away from the second end panel 109 along the fold line 125. Thus, the positioning and adherence of the various panels and sections of the blanks 101-103 enable the cross support to be erected as part of the final assembly of the preassembly as container 100 without additional touches to install the cross support. As a result, the preassembly can be finally assembled either by hand or by an automated or semi-automated piece of equipment due to the lack of complexity of the required operations.

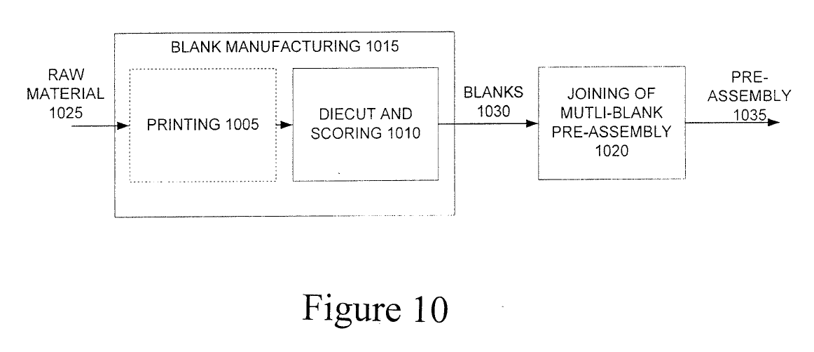

With this understanding of the utility of the invention in mind, FIG. 10 illustrates a functional block diagram used to describe the manufacturing method of containers in accordance with an illustrated embodiment. As alluded to in the background section, and as conventionally known, the manner of manufacturing containers such as the examples illustrated in FIGS. 1-9 may be conveniently described in two phases: preassembly and final assembly/use.

Preassembly manufacture, as described in connection with FIGS. 6-9, is normally performed at a container manufacturing facility to produce a preassembly which may also be thought of and referred to as a knockdown of the container. These preassemblies may be shipped to a customer location such as a product manufacturing facility, retail environment, third party product container manufacturing facility or third party fulfillment contract packaging facility. At that destination, the container customer may perform final assembly of the containers by, for example, folding and assembling various panels, e.g., the bottom panels, of the container to provide a container (e.g., the shipping/display container illustrated in FIG. 1) that is configured to hold manufactured product containers or product.

The manufacturing of the container preassemblies may be performed by the customer of the preassemblies and/or as part of manufacture of the preassemblies as illustrated in FIG. 10. FIG. 10 illustrates various functional operations performed as part of the manufacture of a preassembly by, for example, a display, shipping or display ready packaging manufacturer. The operations may begin, for example, with printing 1005 of container material prior to the container material being die cut and/or scored 1010 as part of an overall blank manufacturing operation 1015. The manufactured blanks 1030 may or may not be printed on one or both sides of the blanks 1030 depending on customer requirements. Accordingly, the printing operation 1005 may be omitted.

Subsequent to blank manufacturing 1015, the manufactured blanks may be affixed to one another as part of the joining of multi-blank preassembly operations 1020. The operations performed at 1020 may be performed in various suitable manners including by hand or using various commercially available machines (for example, those produced by Bahmueller Technologies, Inc. of Charlotte, N.C., USA or Bobst Group North America of Roseland, N.J., USA). Thus, the operations performed at 1020 may produce preassemblies for containers such as that illustrated in FIG. 1.

Therefore, it should be appreciated that one or more of the operations performed to produce blanks, preassemblies, knockdowns and containers may be performed in whole or in part by machines and or human personnel. Moreover, human personnel may utilize one or more different types of machines and/or tools to perform assembly operations performed either to manufacture preassemblies or finally assembled containers.

Thus, at the beginning of such operations, raw material 1025 is used to produce blanks 1030. Such raw materials 1025 may include but are not limited to various grades, types, configurations and combinations of corrugated fiberboard and/or solid paperboard, liner board, board of various fluting types and combinations as well as various types of sealants, non-organic materials and inks and dies of various suitable types.

Another embodiment of the container is illustrated in FIG. 11. Those elements have the same function as in FIG. 1-9 have the same reference numeral. Only the differences between the two embodiments will be explained. This embodiment is for a container requiring less strength. First, the second supplementary blank 103 has been eliminated and the minor section 131 of the first supplementary blank 102 is affixed directly to panel 109 of the primary blank 101. The width of the minor section 133A of the supplementary blank 102 and the panel 113A of the primary blank 101 have been minimized.

As mentioned above, it should be appreciated that the embodiment illustrated in FIGS. 1-9 and 10 is merely one implementation of a design provided according to the invention. Therefore, various other designs may be provided that include end supports in accordance with the invention embodiments.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, various illustrated features of the preassembly and resulting containers may be omitted. Furthermore, it should be understood that invention embodiments are capable of variations practiced or carried out in various ways. Therefore, it should be appreciated that, in accordance with at least one embodiment of the invention, any and all of the walls may be constructed of corrugated cardboard. However, it should be understood that the walls, panels, any tabs on various panels, etc., may be constructed of various industry recognized appropriate materials that meet various transporting and/or display criteria. As a result, it should be understood that containers manufactured in accordance with at least one embodiment of the invention may also be considered “cartons,” which may be considered packaging or display containers, commonly made from cardstock or cardboard. Further, it should be understood that cartons come in many different varieties but most cartons can be folded and assembled from a flat form, known as a carton blank. Thus, it should be understood that the pattern for any blank, preassembly or container may be different than those described herein.

Alternatively, or more specifically, the packaging and/or display containers may be made using corrugated board, e.g., material made by a corrugator (a machine that produces corrugated board by attaching fluting to liners) which is a structured board formed by gluing one or more arched layers of corrugated medium to one or more flat-facing linerboards.

Additionally, it should be appreciated that material used in accordance with at least one embodiment of the invention may be laminated to provide barrier properties. Further, other barrier materials may be used including Ultra Violet (UV), moisture and gas barriers. Additionally, though not discussed in detail herein, it should be understood that any adhesive used to provide a bond between materials used in containers provided in accordance with the invention may include any substance that helps bond two materials together, examples including but not limited to glue and paste.

Further, it should be appreciated that the material used to form the primary blank may be different, stronger, or weaker than the blank used to form the supplementary blank. Thus, for example, use of a supplementary blank that is of a heavier, more durable or stronger material than the material used for primary blank, may provide the increased ease of final assembly as well as increased durability or strength to the resulting container while reducing the amount of material in the container (something of interest for environmental and cost issues).

It should be understood that implementation of the method and system of the present invention involves performing or completing certain selected tasks or steps manually, automatically, or a combination thereof.

It should also be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Additionally, it should be understood that the functionality described in connection with various described components of various invention embodiments may be combined or separated from one another in such a way that the structure of the invention is somewhat different than what is expressly disclosed herein.

Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

As a result, it will be apparent for those skilled in the art that the illustrative embodiments described are only examples and that various modifications can be made within the scope of the invention as defined in the appended claims.

1. A method of manufacturing a container, the method comprising:
cutting a primary blank including a plurality of panels configured to provide an exterior of the container having first and second pairs of opposing panels;
cutting a first supplementary blank having a plurality of sections including a major section and first and second minor sections; and
affixing the first and second minor sections each to an intermediate portion of a respective panel of the first pair of opposing panel of the primary blank and affixing first and second panels of the primary blank together such that, as the primary blank panels are manipulated to form the exterior of the container of the finally assembled container a cross support is formed by the major section of the first supplementary blank intermediate the second pair of opposing panels of the primary blank and dividing the an interior of the finally assembled container into two volumes.

2. The method of claim 1, including cutting a second supplementary blank and wherein the first minor section of the first supplementary blank is affixed to the second supplementary blank, and the second supplementary blank is affixed to one of the first pairs of opposing panels.

3. The method of claim 2, wherein the secondary supplementary blank and the panel to which the secondary supplementary blank is affixed have substantially equal widths so as to form a double wall of the container.

4. The method of claim 3, wherein the second minor section of the first supplementary blank is affixed to a first portion of the first panel of the primary blank, which is one of the first pair of opposing panels, and the second panel of the primary blank is affixed to a second portion of the first panel.

5. The method of claim 4, wherein a sum of a width of the second minor section of the first supplementary blank and a width of the second panel of the primary substantially equal a width of the first panel of the primary so as to form a double wall of the container.

6. The method of claim 1, wherein the second minor section of the first supplementary blank is affixed to a first portion of the first panel of the primary blank, which is one of the first pair of opposing panels, and the second panel of the primary blank is affixed to a second portion of the first panel.

7. The method of claim 6, wherein a sum of a width of the second minor section of the first supplementary blank and a width of the second panel of the primary substantially equal a width of the first panel of the primary so as to form a double wall of the container.

8. A container preassembly comprising:
a primary blank including a plurality of panels configured to provide an exterior of the container having first and second pairs of opposing panels; and
a first supplementary blank having a plurality of sections including a major section and first and second minor sections;
wherein the first and second minor sections each being affixed to an intermediate portion of a respective panel of the first pair of opposing panel of the primary blank and first and second panels of the primary blank being affixed together such that, as the primary blank panels are manipulated to form the exterior of the container of the finally assembled container a cross support is formed by the major section of the first supplementary blank intermediate the second pair of opposing panels of the primary blank and dividing the an interior of the finally assembled container into two volumes.

9. The container preassembly of claim 8, including a second supplementary blank and wherein the first minor section of the first supplementary blank is affixed to the second supplementary blank, and the second supplementary blank is affixed to one of the first pairs of opposing panels.

10. The container preassembly of claim 9, wherein the secondary supplementary blank and the panel to which the secondary supplementary blank is affixed have substantially equal widths so as to form a double wall of the container.

11. The container preassembly of claim 10, wherein the second minor section of the first supplementary blank is affixed to a first portion of the first panel of the primary blank, which is one of the first pair of opposing panels, and the second panel of the primary blank is affixed to a second portion of the first panel.

12. The container preassembly of claim 11, wherein a sum of a width of the second minor section of the first supplementary blank and a width of the second panel of the primary substantially equal a width of the first panel of the primary so as to form a double wall of the container.

13. The container preassembly of claim 8, wherein the second minor section of the first supplementary blank is affixed to a first portion of the first panel of the primary blank, which is one of the first pair of opposing panels, and the second panel of the primary blank is affixed to a second portion of the first panel.

14. The container preassembly of claim 13, wherein a sum of a width of the second minor section of the first supplementary blank and a width of the second panel of the primary substantially equal a width of the first panel of the primary so as to form a double wall of the container.

15. A plurality of blanks for a container preassembly, the plurality of blanks comprising:
a primary blank including a plurality of panels configured to provide an exterior of the container having first and second pairs of opposing panels; and
a first supplementary blank having a plurality of sections including a major section and first and second minor sections;
wherein the first and second minor sections being configured to be affixed to an intermediate portion of a respective panel of the first pair of opposing panel of the primary blank and first and second panels of the primary blank being configured to be affixed together such that, as the primary blank panels are manipulated to form the exterior of the container of the finally assembled container a cross support is formed by the major section of the first supplementary blank intermediate the second pair of opposing panels of the primary blank and dividing the an interior of the finally assembled container into two volumes.

16. The plurality of blanks of claim 15, including a second supplementary blank and wherein the first minor section of the first supplementary blank is be affixed to the second supplementary blank, and the second supplementary blank to be affixed to one of the first pairs of opposing panels.

17. The plurality of blanks of claim 16, wherein the secondary supplementary blank and the panel to which the secondary supplementary blank is to be affixed have substantially equal widths so as to form a double wall of the container when affixed.

18. The plurality of blanks of claim 17, wherein the second minor section of the first supplementary blank is to be affixed to a first portion of the first panel of the primary blank, which is one of the first pair of opposing panels, and the second panel of the primary blank is to be affixed to a second portion of the first panel.

19. The plurality of blanks of claim 18, wherein a sum of a width of the second minor section of the first supplementary blank and a width of the second panel of the primary substantially equal a width of the first panel of the primary so as to form a double wall of the container when affixed.

20. The plurality of blanks of claim 15, wherein the second minor section of the first supplementary blank is to be affixed to a first portion of the first panel of the primary blank, which is one of the first pair of opposing panels, and the second panel of the primary blank is to be affixed to a second portion of the first panel.

21. The plurality of blanks of claim 20, wherein a sum of a width of the second minor section of the first supplementary blank and a width of the second panel of the primary substantially equal a width of the first panel of the primary so as to form a double wall of the container when affixed.
